(19) United States
(12) Patent Application Publication
(10) Pub. No.: US 2026/0238368 A1
(43) Pub. Date: Aug. 13, 2026

(54) METHOD FOR SYNCHRONIZING END DEVICES, COORDINATOR UNIT IN A RADIO NETWORK, END DEVICE AND SYSTEM

(71) Applicant: Siemens Aktiengesellschaft, München (DE)

(72) Inventors: Maik Gruhle, Nürnberg (DE); Eduard Bechtold, Amberg (DE)

(21) Appl. No.: 19/537,865

(22) Filed: Feb. 12, 2026

(30) Foreign Application Priority Data
Feb. 12, 2025 (DE) 10 2025 105 224.7

(51) Int. Cl. H04J 3/06

(52) U.S. Cl. CPC H04J 3/0667

(57) ABSTRACT

A method for synchronizing end devices includes operating the end devices selectively in a first operating mode with a standby operation or in a second operating mode with a continuous operation. A coordinator unit is used to provide radio messages to the end devices selectively with one of two transmission instances. For synchronization, the end devices are switched to the second operating mode in continuous operation and kept in continuous operation. By using exactly one of the two transmission instances, a synchronization message is provided continuously to all end devices at once, i.e. as a broadcast. The synchronization message contains predetermined synchronization information for the synchronization. A coordinator unit, and end device and a system are provided to carry out the method.

### CROSS-REFERENCE TO RELATED APPLICATION

This application claims the priority, under 35 U.S.C. § 119, of German Patent Application DE 10 2025 105 224.7, filed Feb. 12, 2025; the prior application is herewith incorporated by reference in its entirety.

### FIELD AND BACKGROUND OF THE INVENTION

The invention relates to a method for synchronizing end devices and a coordinator unit in a radio network. Furthermore, the invention relates to a coordinator unit, which can be used for the synchronization of end devices. Furthermore, the invention relates to an end device which can be used for synchronizing end devices. Finally, the invention also relates to a system having a plurality of end devices and a coordinator unit which can be used for synchronizing end devices.

For grid operators of a power grid, it is important to know parameters such as apparent, active and reactive power and variables that depend on them, such as the power factor cos φ and generally the load flow direction. For this purpose, it is necessary to measure both the prevailing voltage in a line of an alternating current network and the current synchronously and with high temporal resolution. Those parameters are calculated from a phase position of current and voltage in the power grid, which can be described as a time offset between the two signals. In order to determine the parameters with sufficient precision, a very small time error between the data points of the current and voltage measurement is necessary. If, for example, an accuracy of a phase angle of 1° at a frequency of 50 Hz is to be achieved, an accuracy of 20 ms÷360°=55.55 μs must be achieved.

For example, in order to measure current and voltage, one approach is to use a data coordinator with a sensor for voltage measurement in a distribution station for the power grid and multiple end devices each with a sensor for current measurement. The data coordinator serves as a central evaluation unit to determine the desired parameters from the measurement results of the current measurement and the voltage measurement.

The communication between the coordinator and end devices, for example for the exchange of measurement data, can be implemented by using a radio interface. For example, the Zigbee radio standard is used in existing distribution stations. In that context, the data coordinator can be configured as a Zigbee gateway, for example. For example, so-called Zigbee Sleepy End Devices are used as end devices. They have an independent energy supply (energy harvesting) and are operated in standby operation or standby mode in order to save energy. Thus, their sensors for current measurement are not permanently active. For the current measurement, it is therefore necessary to wait for a “wake-up phase” or operational readiness of the sensors. The measurement values are recorded using Zigbee reporting, wherein the data coordinator receives the measurement values of the Zigbee Sleepy End Devices at regular intervals or periodically. Establishing the connection, the parameterization and sending of further messages from the coordinator unit to the Sleepy End Device are carried out from the Sleepy End Devices by “polling.” That means that messages sent from the coordinator unit to Sleepy End Devices are always unicast messages by definition and are fetched from the end devices by polling.

In order to coordinate the current and voltage measurements, the data coordinator and the end devices each include an internal timing unit or timing device (timer or counter), which is used as the system clock. The system clock sets the rate for performing functions such as sending messages and recording measurement data. However, the timing units do not share a common time base with one another. They are therefore timing units without an absolute time reference. That means that, while the measurement data of the respective end device can be provided with a recording time stamp, in the central evaluation the acquisition times of the measurement data cannot be temporally related to each other or to the measurement data of the coordinator. As a result, it is not possible to determine the time-shifted phase position between current and voltage in the power grid with the required accuracy.

Various approaches to synchronization are known from the prior art to synchronize the end devices, i.e. to find a common time base.

For example, European Patent Application EP 3 993 290 A1 discloses a method for the time synchronization of sensor units in a ZigBee radio network. In that case, an internal timing unit without an absolute time reference is present in each sensor unit. Sensor data is acquired by the sensor units and transmitted via the radio network to a central unit for evaluation. In a central evaluation, a reference time base can be established using a sender identification. In addition, a temporal relation of the transmitted sensor data of the respective sensor unit with respect to the reference time base can be derived based on the stored value of the internal timing unit of the respective sensor unit when receiving a characteristic time feature of a characteristic signal of the central unit, and on the additional stored value of the internal time unit of the respective sensor unit when acquiring the sensor data.

German Patent DE 10 2024 203 105 B3 discloses a synchronization of a transmitter and a receiver in a power grid, for example. That aims to synchronize multiple end devices to a coordinator using a so-called PRS system (Peripheral Reflex System). The synchronization concept is based on two considerations: on the one hand, Zigbee messages are sent and received almost simultaneously, which makes the duration of the transmission negligible. On the other hand, events such as measurement times can be recorded or logged with the PRS system. That synchronization takes place every 10 seconds via a unicast message.

However, the network operator may have specific requirements for the distribution station infrastructure and the synchronization rate. For example, up to 48 end devices with current sensors can be provided in a distribution station (16 outlets per distribution station each with three phases, with one current sensor being required for each phase), which should be synchronized with a synchronization rate of 2 seconds.

However, for a large number of end devices the bandwidth of a ZigBee interface is usually not sufficient to implement a synchronization via unicast within the desired time frame. That means that, based on the requirements, the required accuracy for determining the phase position between current and voltage cannot be achieved with the state-of-the-art systems.

### SUMMARY OF THE INVENTION

It is accordingly an object of the invention to provide a method for synchronizing end devices, a coordinator unit in a radio network, an end device and a system, which overcome the hereinafore-mentioned disadvantages of the heretofore-known methods and devices of this general type and which adapt the synchronization of end devices in a radio network to new requirements with the required accuracy.

With the foregoing and other objects in view there is provided, in accordance with one aspect of the invention, a method for synchronization, in particular time synchronization, of end devices and a coordinator unit in a radio network. The end devices can be operated selectively in a first operating mode with a standby operation or in a second operating mode with a continuous operation. Through the use of the coordinator unit, radio messages are provided to the end devices selectively with one of two transmission instances. Here, selectively means that there are different alternatives to choose from. The selection is made, for example, depending on specified requirements or external influences.

For synchronization, the end devices are switched to continuous operation in the second operating mode and kept in continuous operation. Through the use of exactly one of the two transmission instances, a synchronization message is now provided continuously, i.e. from now on or periodically, to all end devices at once. The synchronization message contains predetermined synchronization information for the synchronization.

In other words, in the radio network a plurality of end devices are connected to exactly one assigned coordinator unit by a radio interface. Preferably, up to 48 end devices are assigned to one coordinator unit.

Advantageous developments are described by the dependent patent claims, the description and the figures.

In the radio network, messages are transmitted by radio. For this purpose, the coordinator unit and the end devices each include a corresponding radio module or radio module. Radio messages are exchanged with the respective radio module. “Exchange” in this case means that the message can be transmitted in both directions. This means that the coordinator unit and the end devices can send and receive radio messages. A “radio message” in the present case is a message transmitted by any wireless means, which can be transmitted by using a wireless communication protocol such as ZigBee, Bluetooth, WiFi, Thread, Z-Wave or other known communication protocols.

Depending on the message type to be sent, the radio module of the coordinator unit now includes two different transmission instances. For example, a first transmission instance is intended exclusively for Zigbee standard messages. A Zigbee standard message is, for example, a message for establishing a connection, for setting parameters of the end devices or for updating the firmware. However, the Zigbee standard message does not contain any synchronization information. For example, only the second transmission instance is provided for synchronization. The synchronization messages are thus provided by using the second transmission instance. These contain the synchronization information, for example a reference time base, which can be used to synchronize the time base of the end devices.

The respective transmission instance can be realized, for example, by using a separate antenna module of the respective radio module. This means that two physically separate transmission stations are provided, preferably in hardware, for sending the radio messages depending on the message type.

Thus, a precise time stamp or transmission time stamp can be determined on the sender side, i.e. on the coordinator unit side, when sending the synchronization message. The timestamps for the synchronization message are therefore not mixed with other transmission timestamps, for example, with those of the Zigbee standard messages, and can always be uniquely assigned to the last synchronization message.

In addition, the end devices are operated in continuous operation for the synchronization. This means that the end devices are permanently active, ensuring that there is permanent readiness to receive radio messages, in particular the synchronization message. At the same time, the synchronization message is provided to all endpoints at the same time. This means that there is no need to send individual messages via unicast for each end device. This results in the advantage that the data traffic across the radio interface can be reduced, since there is no need to additionally request a reception time window from the end devices, for example by polling. This can also increase the transmission rate and thus the synchronization rate, as less data traffic is transmitted via the radio interface.

Preferably, the synchronization in the present case takes place at least every two seconds, in particular every second. This means that a synchronization message is provided at least every two seconds. The synchronization can therefore be performed at a particularly high synchronization rate.

By being able to adjust the operating modes of the end devices, the end devices can be used for different application areas. For example, the end devices can be used to retrofit existing systems or distribution stations without the need for a complex reconfiguration of the system architecture.

The operationally ready mode can also be referred to as standby mode or wait mode. This is a state of an electronic device in which the device is held in a sleep mode, from which it can be quickly restored to normal operation. It can be made ready for operation for its intended function without requiring a longer start-up time. Power consumption in the sleep mode is reduced compared to normal operation. This means that the device does not require a complete reboot. In sleep mode, certain features of the device are disabled.

In contrast, continuous operation is a state of an electronic device in which it is permanently operationally ready or active. In particular, there is no other mode, such as the sleep mode, in which the power consumption is actively reduced.

Preferably, the continuous operation is maintained for at least ten minutes. This means that continuous operation can be maintained for ten minutes or more, for example 30 minutes or one hour or several hours. In connection with the end devices, for example, the radio module is temporarily deactivated in sleep mode. In continuous operation, on the other hand, the radio module remains permanently accessible such that the end device is permanently ready to receive.

“Synchronization” here refers to the fact that data, which is made available by the respective end device to the coordinator unit for central evaluation, is related to a common time base with the coordinator unit. This means that the transmitted data items are to be brought into a temporal relationship with each other in order to establish a temporal relationship between the acquisition times of the data. This is particularly important, as mentioned above, for example, when the end devices in a power grid are equipped with sensors for current measurement and the coordinator unit is equipped with a sensor for voltage measurement and parameters such as active, reactive and apparent power as well as variables derived from them, such as the power flow and power factor, are to be calculated from the measurement results. For this purpose, the phase angle, i.e. the phase shift between current and voltage measurements at a given time, must be determined with high accuracy.

In order to do this, it is necessary for the end devices and the coordinator unit to follow the common time base. For example, information for establishing a common time base is contained in the synchronization information of the synchronization message. The synchronization is carried out here in accordance with known synchronization methods, as described at the beginning, for example.

The invention includes embodiments that result in additional advantages.

In one embodiment, the synchronization message is provided to all end devices at once as a broadcast message. In the field of message transmission, a broadcast is a special form of multipoint connection. Data packets are thus transmitted from one point, in this case the coordinator unit, to all subscribers of a message network simultaneously or jointly. Each recipient of a broadcast, in this case the end devices, can decide for itself whether, in the event it is responsible, it either processes the received message or otherwise silently discards it.

In one embodiment, the respective end device includes an energy harvesting module for generating electrical energy to provide its own energy supply by using energy from the environment. The second operating mode for continuous operation is selected and maintained depending on the energy available in the environment.

In other words, switching between operating modes depends on whether the respective end device can obtain enough energy from the environment to supply it with energy. This means that the end devices are only used in continuous operation as long as the energy or power that the end device can obtain from the environment exceeds a specified limit value. If the energy or power obtained falls below the limit, however, the standby mode is used. The limit value can be set for specific applications. The limit value can be determined, for example, in tests or simulations.

The energy is obtained by using the energy harvesting module. Energy harvesting is a well-known technique for “harvesting” energy from the environment. The energy can come originate, for example, from the ambient temperature, vibrations, air currents or electromagnetic signals, to name just a few examples. For this purpose, the energy harvesting module may include, for example, a suitable component such as a piezoelectric crystal, a thermoelectric generator, an antenna, a photovoltaic cell or, for example, an inductive storage unit, for example in the form of an electrical resonant circuit.

In one embodiment, the ZigBee radio standard is used for providing the radio message. That is, ZigBee is used as the wireless communication protocol. The coordinator unit is also provided or configured as a ZigBee gateway. The gateway can also be referred to as a hub or bridge, depending on the manufacturer. The end devices are provided or configured as ZigBee Sleepy End Devices. ZigBee Sleepy End Devices are end devices that are usually operated in standby mode, as they generate their electrical energy autonomously by energy harvesting. Continuous operation is unusual for these Sleepy End Devices. In continuous operation, the Sleepy End Devices are used for synchronization in a manner similar to a Non-Sleepy End Device, so that they are able to receive messages at any time. However, for other types of communication that do not particularly relate to synchronization, such as the exchange of Zigbee standard messages, the respective end device remains functionally a Sleepy End Device. This means that “polling” is used, for example.

In one embodiment, the respective end device for receiving radio messages, in particular in terms of software, is implemented as a layer architecture. The synchronization message is received via the respective end device in a MAC layer (MAC: Media Access Control).

This means that the software architecture of the end device, in particular of the radio module, is structured according to the OSI layer model, for example. The MAC layer is a sub-layer of the data link layer, which is the second lowest layer of the OSI model. The MAC layer includes network protocols and components which govern how multiple end devices share the shared physical transmission medium. This avoids data collisions, which would result in communication disruptions or data loss. For example, specifications for the MAC layer are described in detail in the IEEE 802.15.4 standard.

In one embodiment, for temporally classifying a plurality of successive synchronization messages during reception by a respective end device, a reception time of the synchronization message in the MAC layer is compared with a reception time which is determined by using a PRS system. In particular, the synchronization message is only processed further for synchronizing the end devices if the reception times match within a specified tolerance range. For example, the tolerance range can be defined for specific applications. The tolerance range can be determined, for example, in tests or simulations. In particular, the tolerance range is in the nanosecond or microsecond range.

This has the advantage that two independent means are used to determine a reception timestamp of the receipt of the synchronization message in the end device. Thus, a plurality of consecutive radio messages received by the respective end device can be assigned to the timestamp of a synchronization message sent by the coordinator unit.

The use of a PRS system (Peripheral Reflex System) for determining a reception time and the synchronization made possible as a result, is known in detail, for example, from the internal prior art mentioned above with application number 10 2024 203 105.4 at the German Patent and Trademark Office.

In one embodiment, a message filter for the synchronization message is provided for the respective end device. The synchronization message is only used for further processing in the respective end device if a specified frame of the synchronization message is identified by using the message filter.

This means that a filter is implemented that can be used to analyze the frame or structure, i.e. the structure of the message. This is because the MAC layer is not usually configured to receive broadcast messages, in particular in the case of ZigBee Sleepy End Devices. These are usually discarded at the MAC layer. The message filter now performs a selective filtering of the structure of the synchronization message in the MAC layer so that the synchronization messages are intercepted and forwarded for further processing. Further processing can take place, for example, in an application layer of the end device. The further processing may include, for example, evaluating or identifying the content of the synchronization message. As a result, the evaluation can provide, for example, a means of synchronizing the end devices.

In one embodiment, as synchronization information the synchronization message includes at least one coordinator reference time specified by the coordinator unit and a delay time specified by the coordinator unit between the coordinator reference time and a time of transmission for the provision of the synchronization message.

With the reference time, a time base to which the coordinator unit is set is thus communicated to the end devices for synchronization. The delay time also takes into account a so-called transmit delay. This arises because a time delay may occur between preparing a message for transmission and the actual time of transmission. Also, the confirmation that the message has been sent is not synchronous, but asynchronous. The same delay also occurs, of course, when receiving the message on the receiver side. Reasons for the delay are, for example, that the radio link is still busy, a microcontroller has to process the data, for example, before it can be used, a microcontroller has to decode the data after reception, or, for example, a computer unit is heavily loaded, which leads to longer transit times.

Preferably, the coordinator reference time transmitted in the current synchronization message and the delay time are time values that have been determined for a previous measurement cycle of the coordinator unit. For example, these are values that can only be determined in concrete terms retroactively, i.e. after the current synchronization message has been sent.

In one embodiment, an end device reference time for determining measurement data by using the end device is adjusted by using the respective end device for synchronization depending on the synchronization message, i.e. in response to receiving the synchronization message.

This means that depending on the synchronization message, in particular on the basis of the coordinator reference time and the delay time, the end device reference time is changed or shifted. This takes into account, for example, the fact that the transmitted coordinator reference time does not necessarily need to match a coordinator reference time in the current measurement cycle. For this purpose, the synchronization message may include, for example, further information with which the respective end device can estimate the coordinator reference time on its own time base and then correct it. The shift is carried out in such a way that the end device reference time matches the coordinator reference time for the current measurement cycle. The coordinator unit and end devices then run on a common time base and are synchronized for recording the measurements, for example for the current measurement. The use of reference times and the delay time for synchronization is known from European Patent Application EP 3 993 290 A1, for example.

The end device can provide the measurement data to the coordinator unit for evaluation. For this purpose, the end device uses the radio interface mentioned earlier. By comparing the reference times, the coordinator unit can now be sure that the timing of the measurement data recording was correct. This allows, for example, the load flow or power factor in the coordinator unit to be determined with the desired accuracy.

In one embodiment, the coordinator unit and the end devices are used in an AC power grid having multiple phases for monitoring a phase shift of an alternating voltage signal and an alternating current signal in the respective phase. For example, the AC power grid may be part of a power distribution station. The power distribution station can be, for example, a transformer station, a distribution substation, or a distribution station between a network operator and end consumers.

As mentioned earlier, the phase shift between the alternating voltage signal and the alternating current signal is an important parameter in calculating the apparent, active and reactive power and variables dependent on them, such as the power factor cos φ and generally the load flow direction. This is required, for example, by a network operator in order to calculate the consumption of an end consumer correctly. The network operator can retrieve the evaluated measurement data from the coordinator unit, for example, and use it for power flow analysis, in particular for reactive power compensation.

In one embodiment, the alternating voltage signal is measured by using a sensor unit of the coordinator unit and the alternating signal for the respective phase is measured by using a sensor unit of the respective end device. Depending on the synchronization message, the phase shift between the alternating voltage signal and the alternating current signal is determined by using the respective end device.

This means that an end device with a current sensor is preferably provided for each phase. In addition, the coordinator unit is equipped with a voltage sensor that measures the voltage of each phase. The current sensor is then used to determine the current of the respective phase, which is phase-shifted with respect to the alternating voltage in the respective phase. This phase shift, in particular the phase angle, should be determined with a high accuracy, for example to the nearest 1°. To this end, the current signal must be measured on the common time base with the voltage signal measurement. However, as mentioned above, due to different system clocks and due to delay times during signal transmission, this does not happen in a radio network. The synchronization message is used to compensate for the resulting timing errors and thus to know the correct phase shift for each measurement cycle.

In one embodiment, a respective zero crossing time of the alternating voltage signal is used as the coordinator reference time. This means that the oscillations of the alternating voltage signal are used to synchronize the current measurement of the end devices. In particular, the zero crossing time preceding the current synchronization message, i.e. for a previous measurement cycle, is transmitted.

For application cases or application situations that may arise in a method according to the invention and that are not described explicitly here, provision may be made, according to the method, for an error message and/or a request for input of user feedback to be output and/or a default setting and/or a predetermined initial state to be set.

With the foregoing and other objects in view there is provided, in accordance with a further aspect of the invention, a coordinator unit having a radio module and a computing unit. The radio module includes at least two transmission instances. These transmission instances can be logically implemented in a common hardware instance, for example as transmit buffer instances, or they can be physically implemented as two separate hardware instances, for example two radio transmitters or radio modules. The coordinator unit is configured to carry out the method according to the invention. In particular, the coordinator unit carries out the method according to the invention. In particular, the coordinator unit can carry out those steps of the method according to the invention which are intended for the coordinator unit.

With the foregoing and other objects in view there is provided, in accordance with an additional aspect of the invention, an end device having a radio module and a computing unit. The end device is configured to carry out the method according to the invention. In particular, the end device carries out the method according to the invention. Preferably, the end device carries out those method steps of the method according to the invention which are intended for the end device.

In the present disclosure, the computing unit can be understood as a data processing system or data processing device. A computing unit may be understood to mean in particular a data processing device containing a processing circuit. The data processing device may thus in particular process data in order to perform computing operations. Optionally, these also include operations for performing indexed accesses to a data structure, for example a lookup table (LUT), as well as a data processing process implemented in hardware.

The data processing device may in particular contain one or more computers, one or more microcontrollers and/or one or more integrated circuits, for example one or more application-specific integrated circuits (ASIC), one or more field-programmable gate arrays (FPGA), and/or one or more systems-on-a-chip (SoC). The data processing device may also contain one or more processors, for example one or more microprocessors, one or more central processing units (CPU), one or more graphics processing units (GPU) and/or one or more signal processors, in particular one or more digital signal processors (DSP). The data processing unit may also contain a physical or virtual group of computers or other ones of the stated units.

In various exemplary embodiments, the data processing unit contains one or more hardware and/or software interfaces and/or one or more memory units.

A memory unit may be configured as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM) or as a phase-change random access memory (PCRAM).

With the foregoing and other objects in view there is provided, in accordance with a concomitant aspect of the invention, a system having a plurality of end devices according to the invention and a coordinator unit according to the invention. The system is configured to carry out the method according to the invention. In particular, the system carries out the method according to the invention.

Further embodiments of the system according to the invention, the coordinator unit according to the invention and the end device according to the invention follow directly from the various embodiments of the method according to the invention and vice versa. In particular, individual features and corresponding explanations as well as advantages with regard to the various embodiments of the method according to the invention can be transferred analogously to corresponding embodiments of the system according to the invention, the coordinator unit according to the invention and the end device according to the invention.

Above and below, the solution according to the invention is described both with respect to the claimed system, the coordinator unit and the end device as well as with respect to the claimed method. Features, advantages or alternative embodiments can be assigned to the other claimed subjects, and vice versa. In other words, the claims and embodiments for the system, the coordinator unit and the end device may be improved by features described or claimed in connection with the respective method. In this case, the functional features of the method are embodied by physical units of the system.

Further features of the invention will become apparent from the claims, the figures and the description of the figures. The features and combinations of features cited above in the description and the features and combinations of features cited below in the description of the figures and/or shown in the figures may be encompassed by the invention not just in the respectively specified combination, but also in other combinations. In particular, embodiments and combinations of features which do not have all the features of an originally formulated claim may also be encompassed by the invention. In addition, embodiments and combinations of features which go beyond or deviate from the combinations of features specified in the claims may include the invention.

Other features which are considered as characteristic for the invention are set forth in the appended claims.

Although the invention is illustrated and described herein as embodied in a method for synchronizing end devices, a coordinator unit in a radio network, an end device and a system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic block diagram of a distribution station for a power grid with a system for synchronizing end devices;

FIG. 2 is a schematic flow diagram of a method for synchronizing end devices in the distribution station; and

FIG. 3 is an exemplary illustration of a structure of a synchronization message for the synchronization of end devices.

### DETAILED DESCRIPTION OF THE INVENTION

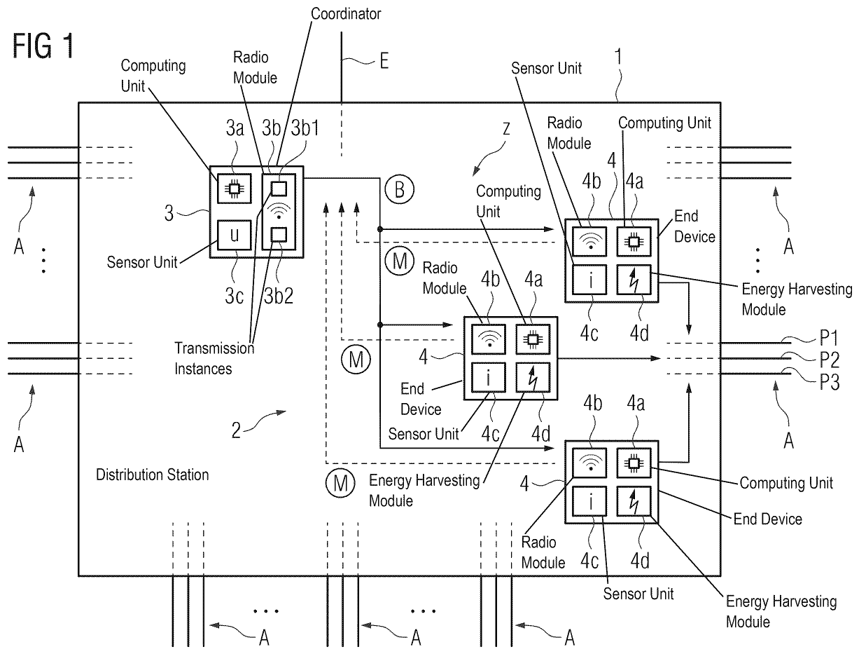

Referring now in detail to the figures of the drawings, in which identical or functionally identical elements may be provided with the same reference signs and in which the description of identical or functionally identical elements is not necessarily repeated with respect to the different figures, and first, particularly, to FIG. 1 thereof, there is seen a schematic illustration of a distribution station 1 for the distribution of electrical energy. The distribution station 1 can be, for example, a transformer station or distribution substation or a distribution station of an energy supplier to different end consumers. The distribution station 1 is implemented for a multi-phase AC power grid. In this case, the distribution station 1 includes an input E and a plurality of outputs A. In the exemplary embodiment according to FIG. 1, six such outputs A are shown by way of example, through the use of which the electrical energy can be transmitted, for example, to the end consumers. However, there can be up to 16 outlets or outputs A present per distribution station 1. For example, each output A includes three phases P1, P2, P3, via which the respective alternating signal, i.e. the current and the voltage, is transported to the end consumer.

In such a distribution station 1, it is important to know about load fluctuations and additional parameters such as apparent, active and reactive power and variables that depend on them, such as the power factor and generally the load flow direction. For this purpose, it is necessary to synchronously measure both the prevailing voltage in a phase P1, P2, P3 and the current with a high temporal resolution. This is because these parameters are calculated from the phase relationship between the current and voltage, which can be described as a time offset, i.e. phase shift or phase angle of the two signals. Current and voltage measurements are performed with a system 2. The system 2 includes a coordinator unit 3, and a plurality of end devices 4. For each phase P1, P2, P3 of each output A, exactly one end device 4 is provided. With 16 outputs A, a total of 48 end devices 4 can be assigned to the coordinator unit 3.

The system 2 is a distributed system. In the distributed system, different modules acquire different measurement data, i.e. in this case current and voltage, which are to be evaluated jointly, i.e. centrally. The central evaluation is carried out here in the coordinator unit 3, in particular by using a computing unit 3a. The evaluation can include, for example, determining the parameters such as apparent, active and reactive power and variables dependent on them, such as the power factor and generally the load flow direction.

As shown in FIG. 1, the end devices 4 and the control unit 3 are connected to each other in a radio network for wireless communication for message transmission. A radio interface is implemented in the system 2 for this purpose. The radio interface in this case is in particular a ZigBee radio interface. This means that the wireless communication between the respective end device 4 and the control unit 3 takes place by radio, namely using the ZigBee radio standard. In the present case, the coordinator unit 3 is configured as a ZigBee gateway, for example. For example, the end devices 4 are configured as so-called ZigBee Sleepy End Devices. Each end device 4 can be configured, for example, as a fuse link (or fuse), i.e. as an electrical fuse. Of course, the described system 2 can also be used for radio standards other than the ZigBee radio standard.

As shown in FIG. 1, the coordinator unit 3 includes, for example, a computing unit 3a, a radio module 3b and a sensor unit 3c. The computing unit 3a is configured, for example, as a data processing device for performing computational operations. For this purpose, the computing unit 3a can include, for example, one or more microcontrollers or microprocessors or other types of computer systems. The radio module 3b is configured for transmitting, in particular for sending and receiving, radio messages. For this purpose, the radio module 3b may include, for example, one or more antennas or radio modules. For sending or delivering radio messages, the radio module 3b in this case includes in particular two logical transmission instances 3b1 and 3b2, which are implemented, for example, as transmission buffers. Alternatively, it is conceivable to provide two physically separate transmission instances. These can be configured as stand-alone radio modules. The coordinator unit 3 uses the transmission instances 3b1 and 3b2 selectively depending on a message type to be sent. The sensor unit 3c includes at least one voltage sensor. Thus, using the sensor unit 3c, it is possible to measure the voltage which is present in particular as an alternating voltage at each phase P1, P2, P3 for each output A.

The respective end device 4 also includes a computing unit 4a, a radio module 4b, a sensor unit 4c and additionally an energy harvesting module 4d. The computing unit 4a is configured, for example, as a data processing device analogously to the computing unit 3a. Likewise, the radio module 4b can be configured analogously to the radio module 3b for transmitting or exchanging radio messages. Unlike the radio module 3b, however, the radio module 4b includes, for example, only one transmission instance. The sensor unit 4c includes at least one current sensor. Using the sensor unit 4c, it is thus possible to measure the current in the phase P1, P2, P3 assigned to the respective end device 4, which is in particular in the form of alternating current. The sensor unit 4c may additionally also include a temperature sensor, not shown in FIG. 1, for detecting a temperature of the respectively assigned phase P1, P2, P3. Together with an absolute value of the current, load fluctuations in the AC power grid can be determined therefrom.

The Energy Harvesting module 4d is used for supplying energy, in particular autonomously supplying energy, to the respective end device 4. The electrical energy for its own energy supply is generated by so-called energy harvesting from the environment of the respective end device 4. Such modules are typical of Zigbee Sleepy End Devices. In this case, the energy is harvested or collected from the environment, for example, by electromagnetic waves which are generated during the transmission of alternating signals via the respective phase P1, P2, P3. The electrical energy for the energy supply is generated, for example, by inductive energy transfer. For this purpose, the Energy Harvesting module may include, for example, an electrical resonant circuit with a choke (electrical coil) and an electrical capacitor. The energy supply to the end device is thus autonomous. There is therefore no need for a separate energy source, such as a battery or a connection to an external energy storage device.

In order to keep the energy consumption for the end device 4 low, Zigbee Sleepy End devices are usually operated in a standby mode. This is a first operating mode, in which the end device 4 is regularly switched to a standby mode or sleep mode. In the standby mode, many functions of the end device 4 are deactivated. As a result, power consumption is particularly low. At the same time, however, the end device 4 can be quickly “woken up” from the standby mode and thus made ready for operation without a complete reboot.

However, in this case a different second operating mode is also provided for the respective end device 4. The second operating mode is a continuous operation, in which no transfer to the sleep mode takes place. The end device is therefore constantly ready for operation. All functions are permanently active. It is possible to switch between the first and second operating modes as required.

In order to implement the data evaluation centrally in the coordinator unit 3, the end devices 4 can transmit their respective measurement data M, which contains information about the measured current signal, to the coordinator unit 3 by using the radio interface. Analogously, the coordinator unit 3 can transmit, for example, a trigger signal for triggering a current measurement transmitted to the end devices 4. For the evaluation, it is important that the respective measurement data M of the current measurement is in a temporal relationship to the voltage measurement. This is the only way to avoid time errors between the data points of the current and voltage measurement and to determine the phase angle with a desired accuracy of, for example, 1°.

In order to do this, the measurements must be synchronized. In order to set a clock rate for the measurements or perform them periodically, the coordinator unit 3 and each of the end devices 4 includes an internal timing unit. The timing unit can be understood as an internal counter or system clock. It can be referred to as a timer or counter and be implemented, for example, as a functional module in the respective computing unit 3a, 4a. The respective computing unit can be used to count events, measure time intervals and implement the periodic execution of functions, such as measuring current and voltage.

However, the timing units do not share a common time base with one another. These are therefore timing units without an absolute time reference. As a result, the measurement results can be provided with a time stamp as they are acquired by the respective sensor, which is made available to the central evaluation. Without a common time base, the acquisition times of the sensor units and the acquisition time of the coordinator unit cannot be temporally related to each other.

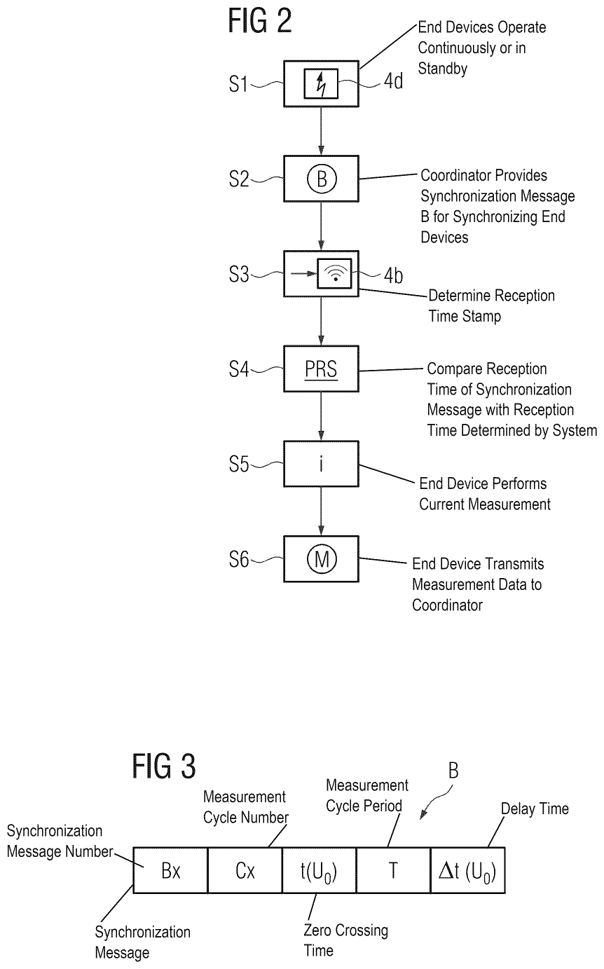

With the system shown in FIG. 1, it should now be possible to synchronize the end devices 4 with the coordinator unit 3. This means that a common time basis for the individual current and voltage measurements will be established. In order to do this, the system 2 can carry out a method for synchronizing the end devices 4. FIG. 2 shows a schematic method flow diagram for a corresponding method.

In a step S1, the first mode selected for operating the end devices 4 is continuous operation, i.e. the second operating mode. For example, the continuous operation can be set or implemented as the default setting for the end devices 4 when used in the system 2. When used in the system 2, the end devices 4 are preferably kept in continuous operation permanently. However, it can happen that, for example, there is no longer enough energy available to supply energy by using the Energy Harvesting module 4d to keep the end devices 4 fully ready for operation. Then it is possible to switch, for example, from continuous operation into the first operating mode, i.e. into standby operation. As soon as sufficient energy is available from the environment again, continuous operation is preferably resumed. This means that operation in continuous mode is carried out in particular depending on the energy available in the environment.

In a step S2, a synchronization message B for the synchronization of the end devices 4 is then provided by the coordinator unit 3. The synchronization message B is transmitted to all assigned end devices 4 in the system 2 at the same time by using the radio interface. That is, the synchronization message B is a broadcast message.

The synchronization message B is sent exclusively by using exactly one of the two transmission instances 3b1, 3b2, for example with transmission instance 3b1. The other transmission instance 3b2 is intended, for example, exclusively for the transmission of Zigbee standard messages. For example, a precise transmission time stamp can be determined on the sender side when sending the broadcast message, because the time stamps from the two transmission instances are not mixed and can therefore always be uniquely assigned to the last synchronization message B.

The synchronization messages B in the system 2 are preferably sent continuously or periodically, for example every 2 seconds. The time of transmission is based, for example, on a specified coordinator reference time. The reference time may be, for example, a time of the zero crossing of the measured alternating voltage signal. This means that the coordinator unit 3 sends the synchronization message B time-synchronously with the zero crossing time of the alternating voltage signal.

Between the preparation for sending the broadcast message, the time of transmission, and the time of reception and processing the fact that data has been received, a transmission delay can occur. Reasons for the delay are, for example, that the radio link is busy, the data must be first processed by the respective microcontroller before it is sent or decoded after receipt, or the microcontrollers are currently heavily loaded, which results in higher transit times. However, for synchronization, it is important to compensate for this transmission delay. For this purpose, specific contents, namely predefined synchronization information are transmitted to the respective end device 4 with the synchronization message B, on the basis of which the respective device can adjust its end device reference time to match the reference time of the coordinator unit 3.

FIG. 3 shows a schematic representation of an example structure and content of the synchronization message B. FIG. 3 thus represents a so-called sync frame for the synchronization message B. The synchronization message B contains five different data points as synchronization information. As a first item, a synchronization message number Bx (Sync Frame Number), i.e. the number of the transmitted synchronization message, is transmitted in the synchronization message B. It specifies the number of synchronization messages B transmitted. This allows the respective end device 4 to verify, for example, whether it has continuously received all transmitted synchronization messages B, or whether, for example, synchronization messages B have been lost during transmission.

As a further data point, the synchronization message B contains, for example, the measurement cycle number C (Main Cycle Number), which indicates which measurement cycle the zero crossing refers to. As a further data point, the synchronization message B includes, for example, the zero crossing time t(U₀). This serves as a reference time for the coordinator unit 3 and indicates the time at which the alternating voltage passes through the zero point. For example, this value can be specified with a resolution of one microsecond. The zero crossing times t(U₀) for each measurement cycle in the synchronization message B are provided by the coordinator unit 3 with a respective count value or time value of the counter unit of the coordinator unit 3. The time value is, so to speak, tacked onto the zero crossing time t(U₀) as a time stamp.

As a further data point, the synchronization message B contains, for example, the measurement cycle period T (Main Cycle Period), i.e. the duration of a previous measurement cycle of the measured voltage signal. This value can also be acquired, for example, with a resolution of one microsecond. Finally, the synchronization message B includes, for example, a delay time Δt(U₀), i.e. a zero cross delay, as a data point. The delay time Δt(U₀) indicates the delay between the reference time of the coordinator unit, i.e. in this case the zero crossing time t(U₀), and the actual start of transmission of the synchronization message B. This value can also be acquired with a resolution of one microsecond. The delay time Δt(U₀) is calculated immediately after the transmission of each synchronization message B. Since the delay time Δt(U₀) for each measurement cycle is only retrospectively known, i.e. after sending a synchronization message B, the current synchronization message B contains the delay time for the previous synchronization message.

Based on this content, inter alia, the respective end device 4 can now adjust or shift its reference time base when receiving the synchronization message B, in order to be synchronized with the time base of the coordinator unit 3. The transmitted synchronization message is received in particular in a Media Access Control (MAC) layer according to the OSI layer model. However, normal Sleepy End devices do not provide a facility to receive broadcast messages. These are usually discarded on the MAC layer. Therefore, in this case a message filter is implemented, through the use of which the specified frame, i.e. the sync frame of the synchronization message B, can be identified. For example, the filter can be implemented in such a way that it first recognizes a predefined broadcast address that is assigned to the synchronization message B. The broadcast address allows the filter to uniquely identify the synchronization message B as a broadcast message. The filter is then used to check whether the frame, i.e. the structure of the message, matches a predefined structure, i.e. for example the structure shown in FIG. 3, of the synchronization message B. If the structure matches, the synchronization message is intercepted at the MAC layer and forwarded, for example, to an application layer for further processing. Without this filtering, all broadcast messages would be discarded in the end devices 4.

When the synchronization message is received in the MAC layer, the timing unit of the respective end device 4 creates a precise reception time stamp and assigns it to the synchronization message B. In a step S3, a reception time stamp of the synchronization message is additionally determined by using a PRS system of the computing unit 4a (Peripheral Reflex System). The PRS system allows hardware events to be mapped as a source to other hardware events or interrupts. The use of a PRS also allows the events to be mapped to a timer periphery, i.e. to time stamps created using the system or the timing unit. Thus, the activity of the receiver radio module can be locked relative to the system time.

In step S4, the time of reception of the synchronization message B in the MAC layer is now compared with a reception time which is determined by the PRS system. For example, the synchronization message B is only processed further in the application layer if the receive times match each other within a specified tolerance range. “Match” here means that the reception times are substantially identical, or differ only by a small amount. The combination of MAC reception time stamp and PRS method represents an improvement for matching multiple consecutive receive messages to the time stamp of exactly one synchronization message B.

In a step S5, the respective end device 4 now performs the current measurement. For this purpose, the respective end device 4 estimates the zero crossing time for the current period of the alternating voltage signal depending on the synchronization message B and the associated time values of the coordinator unit 3. These estimates are based on the values of the voltage signal from previous measurement periods as a result of the content of the synchronization messages B and may therefore differ from those of the current measurement period. However, based on the estimated times and the period T, the respective end device can adjust the phase and frequency of reference signals that simulate the voltage signal, as well as the phase and angular frequency of the measured current signal. Then, based on the corrected reference signals, the respective end device can calculate the absolute value of the current, for example as an RMS value (Root Mean Square value), and the current phasor, i.e. the complex amplitude including the amplitude and the zero phase angle of the current signal.

By adjusting the phase and the angular frequency, the reference time, i.e. the zero crossing time, which the respective end device 4 uses, is adjusted, i.e. synchronized, to the actually measured zero crossing time t(U₀) of the coordinator unit 3. As a result, the current is measured in the correct phase, i.e. with the correct phase angle with respect to the voltage. Timing errors that cause the phase angle to shift and thus affect the power flow evaluation, for example, are prevented.

In a step S6, the respective end device 4 then transmits the measurement data, which contains, for example, the current phasor and the absolute value of the current, to the coordinator unit 3 by using the radio interface. In order then to assign the measurement data M to the individual end devices 4 and the measurement time of the voltage measurement, the measurement data M includes, for example, an identifier for uniquely assigning the synchronization message B through the use of which the measurement was made. This could be, for example, the previously mentioned synchronization message number Bx. It may also include, for example, an end device identification for the unique assignment of the sending end device. In the central evaluation in the coordinator unit 3, for example, to determine load fluctuations or the power flow, a reference time base can now be established using the sender identification. In addition, based on the stored time of reception of the timing unit of the respective end device, a temporal relation of the transmitted measurement data M of the respective end device 4 to the reference time basis can be derived. The synchronization to the common reference time base described in this document is in principle carried out according to known synchronization methods. One of these is disclosed in European Patent Application EP 3 993 290 A1.

Overall, the exemplary embodiments show a broadcast-based synchronization of a high number of Zigbee Sleepy End devices.

Irrespective of the grammatical gender of any particular term, persons identifying as male, female or any other gender are included.

The following is a summary list of reference numerals and the corresponding structure used in the above description of the invention:
1 Distribution station
2 System
3 Coordinator unit
3a Computing unit
3b Radio module
3c Sensor unit
3b1 transmission instance
3b2 transmission instance
4 End device
4a Computing unit
4b Radio module
4c Sensor unit
4d Energy Harvesting module
A Outputs
B Synchronization message
Bx Synchronization message number Bx
C Measurement cycle number
D Zero crossing time
E Input
P1-P3 phases
S1-S6 method step
T measurement cycle period
Δt delay time
U₀ Zero crossing time

1. A method for synchronizing end devices and a coordinator unit in a radio network, the method comprising:
selectively operating the end devices in a first operating mode with a standby operation or in a second operating mode with a continuous operation;
using the coordinator unit to selectively provide radio messages to the end devices with one of two transmission instances;
switching the end devices to continuous operation in the second operating mode and keeping the end devices in continuous operation for the synchronization; and
using exactly one of the two transmission instances to continuously provide a synchronization message to all of the end devices at once, the synchronization message for the synchronization containing predetermined synchronization information.

2. The method according to claim 1, which further comprises providing the synchronization message to all of the end devices at once as a broadcast message.

3. The method according to claim 1, which further comprises providing each respective end device with an energy harvesting module for generating electrical energy for supplying energy by using energy from the environment, and selecting and maintaining the second operating mode for operation in continuous mode depending on energy available in the environment.

4. The method according to claim 1, which further comprises using the Zigbee radio standard for providing the radio messages, providing the coordinator unit as a Zigbee gateway, and providing the end devices as Zigbee Sleepy End Devices.

5. The method according to claim 1, which further comprises implementing each respective end device as a layered architecture for receiving radio messages, and receiving the synchronization message by using the respective end device in a MAC layer.

6. The method according to claim 5, which further comprises comparing a reception time of the synchronization message in the MAC layer with a reception time determined by using a PRS system, for temporally classifying a plurality of successive synchronization messages during reception by a respective end device.

7. The method according to claim 1, which further comprises providing a message filter for the synchronization message for each respective end device, and only using the synchronization message in the respective end device for further processing when a predefined frame of the synchronization message is identified by using the message filter.

8. The method according to claim 1, which further comprises providing the synchronization message with at least one coordinator reference time specified by the coordinator unit and a delay time specified by the coordinator unit between the reference time and a time of transmission for the provision of the synchronization message.

9. The method according to claim 1, which further comprises for the synchronization, depending on the synchronization message, using each respective end device to adjust an end device reference time for a determination of measurement data by using the respective end device.

10. The method according to claim 1, which further comprises using the coordinator unit and the end devices in an AC power grid having multiple phases for monitoring a phase shift of an alternating voltage signal and an alternating current signal in a respective phase.

11. The method according to claim 10, which further comprises measuring the alternating voltage signal by using a sensor unit of the coordinator unit and measuring the alternating current signal for the respective phase by using a sensor unit of the respective end device, and determining the phase shift of the alternating current signal with respect to the alternating voltage signal by using each respective end device depending on the synchronization message.

12. The method according to claim 11, which further comprises providing the synchronization message with at least one coordinator reference time specified by the coordinator unit and a delay time specified by the coordinator unit between the reference time and a time of transmission for the provision of the synchronization message, and using a respective zero crossing time of the alternating voltage signal as the coordinator reference time.

13. A coordinator unit, comprising a radio module and a computing unit, the radio module having at least two transmission instances, and the coordinator unit configured to carry out the method according to claim 1.

14. An end device, comprising a radio module and a computing unit, the end device configured to carry out the method according to claim 1.

15. A system, comprising:
a plurality of end devices each including a radio module and a computing unit; and
a coordinator unit including a radio module and a computing unit, the radio module of the coordinator unit having at least two transmission instances;
the system configured to carry out the method according to claim 1.
